(19) United States
(12) Patent Application Publication
(10) Pub. No.: US 2016/0125480 A1
(43) Pub. Date: May 5, 2016

(54) ENGAGING A POTENTIAL PROPERTY SELLER TO CAPTURE COMPREHENSIVE PROPERTY INFORMATION

(71) Applicant: Christopher Hugh Morrison, Phoenix, AZ (US)

(72) Inventor: Christopher Hugh Morrison, Phoenix, AZ (US)

(21) Appl. No.: 14/527,423

(22) Filed: Oct. 29, 2014

(51) Int. Cl. G06Q 30/02

(52) U.S. Cl. CPC G06Q 30/0278; G06Q 50/16

(57) ABSTRACT

A system and a process for capturing potential home seller information are disclosed. The system and the process provide a better way to procure lead data and home seller data by making the home valuation process more engaging and causing more seller to enter more accurate information during the process. In some embodiments, the system is implemented as a website service. In some embodiments, the process is implemented over several web pages of the website.

### BACKGROUND

Embodiments of the invention described in this specification relate generally to home valuation processes, and more particularly, to obtaining accurate and comprehensive home seller information to use in home valuations.

Home valuation is an information intense process by which a home is valued according to several different data points. For instance, the year a home is built, the types of materials used in constructed the home, the types of fixtures in the home, and a variety of other factors go into a valuation of a home.

This process is especially important when a person intends to sell a home. However, the existing systems and procedures for obtaining the home information is typically not very effective. For example, many of the existing home valuation web site-based systems ask for seller information in one step and are not effective in quickly and comprehensively capturing all of the needed data. Thus, the existing systems and processes are problematic for professionals who market to homeowners and home sellers.

Therefore, what is needed is a better way to procure lead data and home seller data by making the home valuation process more engaging and causing more seller to enter more accurate information during the process.

### BRIEF DESCRIPTION

Embodiments of the invention include a novel home seller lead data procurement system and a novel home valuation information retrieval process for capturing potential home seller information in an engaging and comprehensive manner and causing potential home sellers to enter accurate and complete information.

The home seller lead data procurement system of some embodiments includes a web server that hosts a lead data procurement website. In some embodiments, the lead data procurement website comprises a plurality of web pages. The plurality of web pages are displayed in sequence to a user of the home seller lead data procurement system of some embodiments. The plurality of web pages, in some embodiments of the system, display requests for information and data input fields for the user to enter home seller information related to the requests for information.

The home valuation information retrieval process of some embodiments includes a plurality of steps for capturing potential home seller information. In some embodiments, the home valuation information retrieval process includes (i) establishing a home seller lead data procurement website, (ii) prompting a user of the website to input an address, (iii) identifying a property associated with the address, (iv) displaying a map of the property, (v) receiving a set of property information and a set of user information, (vi) automatically determining a valuation for the property, (vii) displaying the valuation to the user, (viii) saving the property valuation in a data storage, (ix) offering the user an opportunity to be contacted by a professional, and (x) alerting the professional when the user wants to be contacted.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of a home seller lead data procurement system in some embodiments.

FIG. 2 conceptually illustrates a home valuation information retrieval process for capturing potential home seller information in an engaging and comprehensive manner in some embodiments.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Embodiments of the invention include a novel home seller lead data procurement system and a novel home valuation information retrieval process for capturing potential home seller information in an engaging and comprehensive manner and causing potential home sellers to enter accurate and complete information.

### I. Home Seller Lead Data Procurement System

As stated above, professionals that market to homeowners need a better way to procure lead data. Embodiments of the invention described in this specification solve such problems by a system and a process that allows interested homeowners to enter their home address and contact information online to receive their home's value.

In some embodiments, the home seller lead data procurement system includes a web server that hosts a lead data procurement website. In some embodiments, the lead data procurement website comprises a plurality of web pages. In some embodiments, the plurality of web pages are displayed in sequence to a user of the system. In some embodiments, the plurality of web pages display requests for information and data input fields for the user to enter home seller information related to the requests for information.

The home seller lead data procurement system of some embodiments differs from and improves upon currently existing systems. In some embodiments, the home seller lead data procurement system engages a homeowner and makes it easy for the home owner to enter contact information with the intention to obtain the current value of the home. Home sellers using existing web-based valuation systems do not engage well with the currently existing single web page operations. In contrast, the home seller lead data procurement system of the present disclosure provides a highly engaging home valuation website which encourages home sellers to be thorough and comprehensive in the information the home sellers provide, thereby causing more home sellers to enter more accurate and comprehensive information when on web pages of the website.

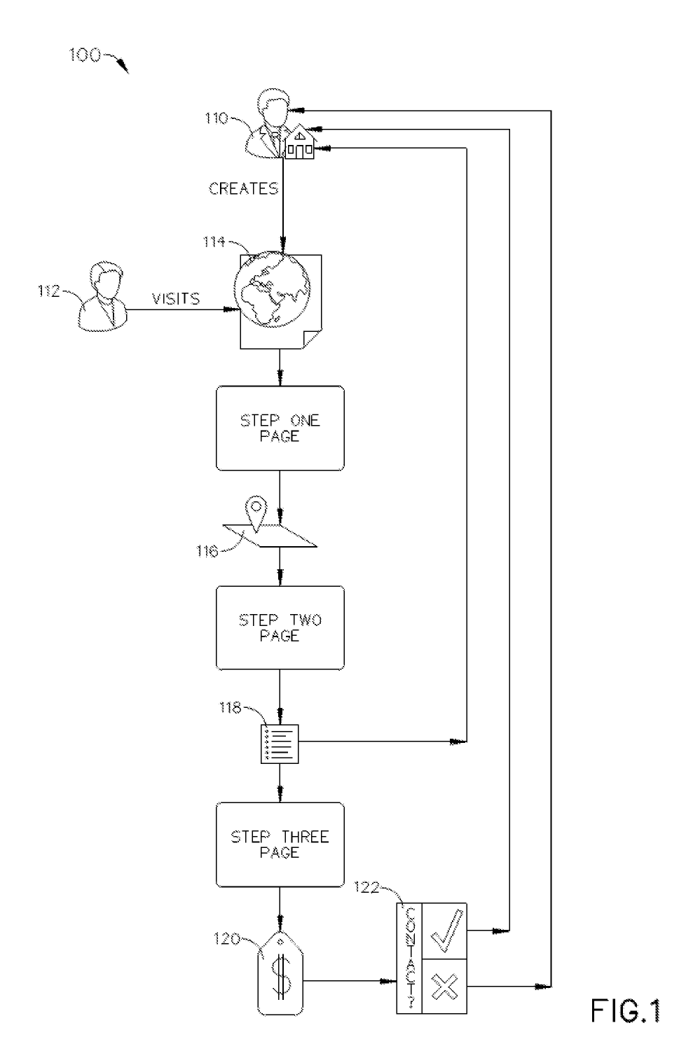

By way of example, FIG. 1 conceptually illustrates a schematic view of a home seller lead data procurement system 100 in some embodiments. As shown in this figure, the home seller lead data procurement system 100 includes different operators who engage in a process for determining home valuation. One of the operators is a real estate agent 110 or other related real estate professional. Another operator is a home seller or user 112 of the home seller lead data procurement system 100.

The operations start by the real estate agent 110 creating a website 114 for users, such as home seller user 112, to interact with the home seller lead data procurement system 100. The website 114 gets created by the agent 110, and is then hosted on a web server computing device, to allow users to connect to the website 114 and interact with the home seller lead data procurement system 100. In this way, the user 112 can visit the website 114. The user may use a computing device with a web browser software application or a mobile computing device with a mobile application to visit the website 114 and interact with the home seller lead data procurement system 100.

The user 112 proceeds to interact with the home seller lead data procurement system 100 through a sequence of web pages associated with the website 114. For instance, a first web page may prompt the user 112 to input an address of the home (e.g., “enter your home address here to receive your home valuation”). In some embodiments, the system 100 will automatically populate an address as the user 112 starts inputting an address in the home address input field (i.e., the input field displayed on the first web page).

In some embodiments, after the user 112 inputs an address of the home, a location 116 may be identified and the first web page may transition to a second web page which displays an aerial map of the home at the identified address and which indicates that the user's home has been found (e.g., displaying a messaging stating: “we have found your home”). In some embodiments, the system 100 requests property information from the user (e.g., displaying a message next to the aerial map stating: “tell us about your property”). In some embodiments, a fillable form 118 is displayed for the user to interact with and fill in the details about the property. In some embodiments, the fillable form 118 includes data entry fields for contact information (e.g., phone number, email address, etc.) of the user 112.

In some embodiments, the system 100 displays a tool that allows the user to proceed to the home valuation upon completing the form. For example, the system 100 may display an “OK” or “continue to valuation” button after the user has entered data into each required field of the fillable form. When the tool is displayed, the user may then interact with the tool (e.g., click the button using a mouse, touch screen, etc.) to get the requested valuation of the home.

In some embodiments, after the user 112 interacts with the tool to proceed to the home valuation, the system 100 automatically generates a home valuation 120 and transitions to a third web page to display a confirmation that the information about the property and the request for the home valuation was received. In some embodiments, the system 100 also displays the home valuation 120. In some embodiments, the confirmation is displayed before the home valuation, while in other embodiments, the confirmation is displayed contemporaneously with the home valuation.

In some embodiments, the system also displays a tool that allows the user 112 to select an option to have a local area real estate agent contact them for a more accurate home valuation. When the user 112 selects this option, the system 100 of some embodiments informs the real estate agent 110 of the home information, home valuation, and any new and/or updated contact information from the user 112. For example, the system 100 may send a push notification to the real estate agent 110 with the home information, the home valuation, the contact information of the user 112, and a message directing the real estate agent 110 to contact the user 112.

After this is completed, the system 100 may save the generated home valuation 120 and associated address in a database for future retrieval and/or comparison. In some embodiments, the user's contact information and the user-provided home information is also saved in the database, while in other embodiments, the user is able to select whether or not the contact information of the user is stored in the database along with the valuation and details of the home. In addition, the system 100 may also notify the real estate agent 110 of the valuation price 120. The system may continue processing valuation requests from the same user or, simultaneously or at different times, process valuations from multiple different users accessing the website 114 of the home seller lead data procurement system 100.

When real estate agents use the system 100, including the web site and three step web page process, there is a much higher retention rate among potential home sellers and more sellers put in more accurate information on the website.

While the example home seller lead data procurement system 100 described by reference to FIG. 1 involves three web pages associated with a process, a person skilled in the relevant art would appreciate that the website may include more than three web pages or less than three web pages, depending on the scope of information needed to process a valuation request from a user. The next section provides greater details of the process for capturing potential home seller information.

### II. Home Valuation Information Retrieval Process

In some embodiments, the home valuation information retrieval process includes a plurality of steps for capturing potential home seller information. The process of some embodiments includes (i) establishing a home seller lead data procurement website, (ii) prompting a user of the website to input an address, (iii) identifying a property associated with the address, (iv) displaying a map of the property, (v) receiving a set of property information and a set of user information, (vi) automatically determining a valuation for the property, (vii) displaying the valuation to the user, (viii) saving the property valuation in a data storage, (ix) offering the user an opportunity to be contacted by a professional, and (x) alerting the professional when the user wants to be contacted.

Some embodiments of the home valuation information retrieval process differ from and improve upon currently existing processes. In some embodiments, the home valuation information retrieval process engages a homeowner and makes it easy for them to enter their contact information with the intention to get their homes current value. Home sellers using existing web-based valuation processes do not manage to keep the attention of the home sellers, typically displaying a huge list of information requests which often overwhelms the home seller. In contrast, the home valuation information retrieval process of some embodiments engages a user by presenting requests for information over several separate web pages. In this way, the process is highly engaging to a home seller from the start of the home valuation process.

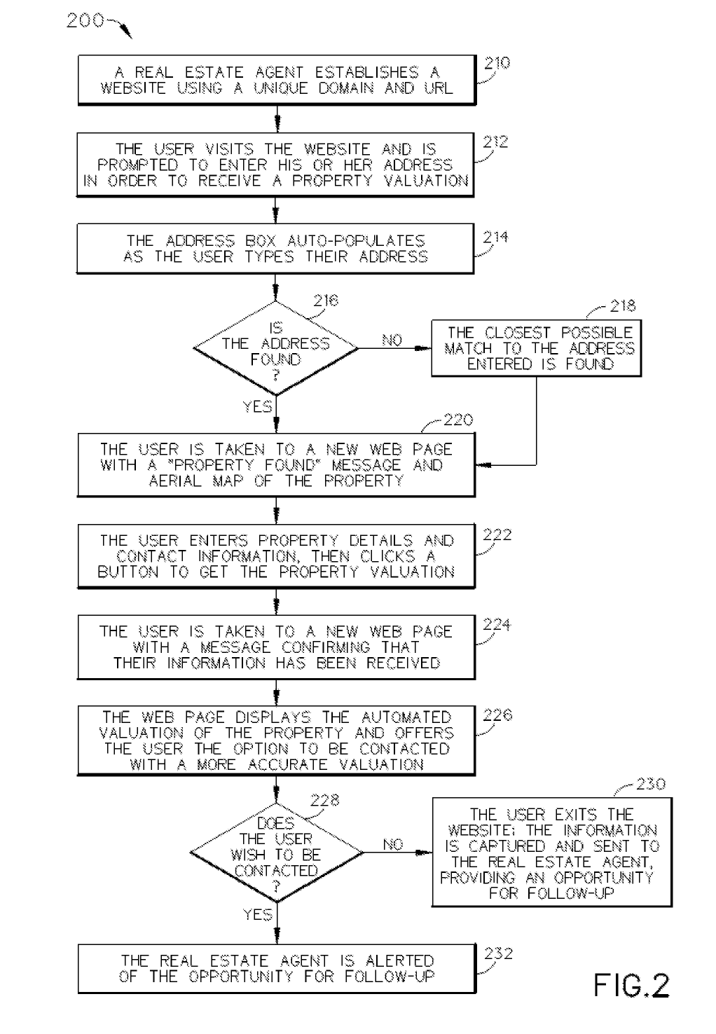

By way of example, FIG. 2 conceptually illustrates a home valuation information retrieval process 200 for capturing potential home seller information in an engaging and comprehensive manner. As shown in this figure, the process 200 starts when a real estate agent establishes (at 210) a website using a unique domain name and URL (or web address). Next, the process 200 prompts (at 212) a user visiting the website to input an address of a home to receive a property valuation. As the user inputs an address, the process 200 of some embodiments automatically populates (at 214) the address when the address is matched. In some embodiments, the process 200 searches for addresses in a database of addresses. In some embodiments, the search is performed by the process 200 contemporaneously with the user inputting the address into the address field. For example, the user may begin typing in an address (e.g., “1243 McDa”) and the process may identify a potential matching address (e.g., “1243 McDaniels Court, Big City, Calif., USA”) and automatically fill the field. If the user continues to type characters that are different (e.g., “1243 McDade S”), the process may attempt to identify another address to auto populate in the field (e.g., “1243 McDade Street, Small City, Calif., USA”).

Next, the process 200 determines (at 216) whether the address was found. When no address is found, the process 200 identifies (at 218) the closest possible match to the address entered by the user. When a matching address is found, however, the process 200 transitions (at 220) to the new web page for display on the user's computing device. On the new web page, a statement is displayed indicating that the user-input address is associated with a property that was found. In some embodiments, the process also displays an aerial map of the property.

The process 200 then receives (at 222) property details input by the user. In some embodiments, the process also receives user contact information after user selects an option to get the home valuation. The process 200 then transitions (at 224) to a new web page which displays a message confirming that the user's property information and contact information have been received. The process 200 also displays (at 226) the automated valuation of the property and offers the user an option to be contacted by a real estate professional for a more accurate valuation.

Next, the process 200 determines (at 228) whether the user would like to be contacted or not. When the user does not wish to be contacted, the process 200 captures (at 230) the information about the property and sends to the real estate agent to provide for further follow-up if the opportunity presents itself On the other hand, when the user indicates a desire to be contacted, the process alerts (at 232) the real estate agent to contact the user, providing both the property information (details and valuation) and the user's contact information. Then the process 200 ends.

The home valuation information retrieval process of the present disclosure may be implemented by a website comprising a plurality of web pages. In some embodiments, a user of the website engages with the process over a sequence of steps of the home valuation information retrieval process. In some embodiments, each step is presented in a separate web page of the web site.

The example home seller lead data procurement system 100 described by reference to FIG. 1, above, has a set of possible web pages which may be included in a website implementing the home valuation information retrieval process. This list of possible constituent web pages is intended to be exemplary only and it is not intended that this list be used to limit the system or process of the present application to just these web pages. Persons having ordinary skill in the art relevant to the present disclosure may understand there to be more or fewer web pages or equivalent elements (such as mobile app pages) that may be substituted within the present disclosure without changing the essential function or operation of the system or process.

The above-described embodiments of the invention are presented for purposes of illustration and not of limitation.

### III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

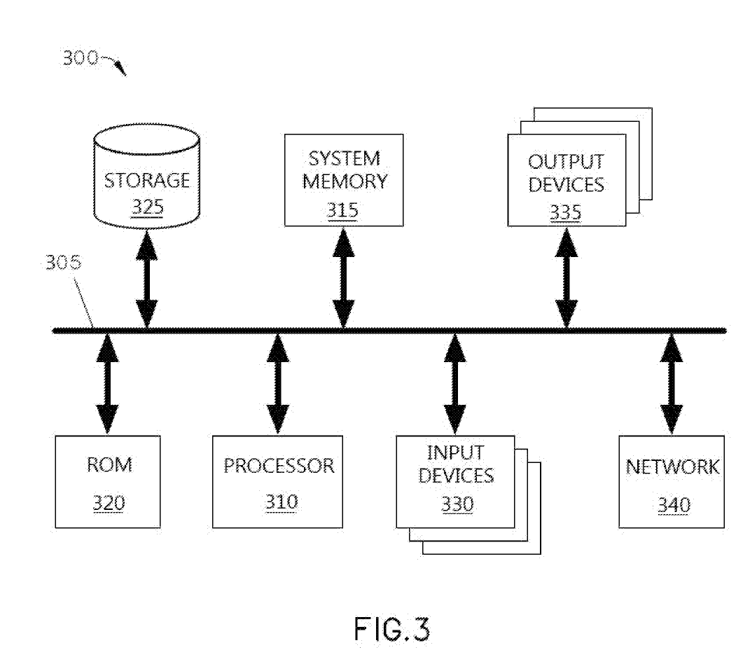

FIG. 3 conceptually illustrates an electronic system 300 with which some embodiments of the invention are implemented. The electronic system 300 may be a computing device, such as a desktop computer, a laptop computer, a tablet computing device, a portable hand-held computing device, a portable communications devices (such as a mobile phone), a personal digital assistant (PDA) computing device, or any other sort of electronic device. Such an electronic system includes various types of computer readable media and interfaces for various other types of computer readable media. Electronic system 300 includes a bus 305, processing unit(s) 310, a system memory 315, a read-only 320, a permanent storage device 325, input devices 330, output devices 335, and a network 340.

The bus 305 collectively represents all system, peripheral, and chipset buses that communicatively connect the numerous internal devices of the electronic system 300. For instance, the bus 305 communicatively connects the processing unit(s) 310 with the read-only 320, the system memory 315, and the permanent storage device 325.

From these various memory units, the processing unit(s) 310 retrieves instructions to execute and data to process in order to execute the processes of the invention. The processing unit(s) may be a single processor or a multi-core processor in different embodiments.

The read-only-memory (ROM) 320 stores static data and instructions that are needed by the processing unit(s) 310 and other modules of the electronic system. The permanent storage device 325, on the other hand, is a read-and-write memory device. This device is a non-volatile memory unit that stores instructions and data even when the electronic system 300 is off. Some embodiments of the invention use a mass-storage device (such as a magnetic or optical disk and its corresponding disk drive) as the permanent storage device 325.

Other embodiments use a removable storage device (such as a floppy disk or a flash drive) as the permanent storage device 325. Like the permanent storage device 325, the system memory 315 is a read-and-write memory device. However, unlike storage device 325, the system memory 315 is a volatile read-and-write memory, such as a random access memory. The system memory 315 stores some of the instructions and data that the processor needs at runtime. In some embodiments, the invention's processes are stored in the system memory 315, the permanent storage device 325, and/or the read-only 320. For example, the various memory units include instructions for processing appearance alterations of displayable characters in accordance with some embodiments. From these various memory units, the processing unit(s) 310 retrieves instructions to execute and data to process in order to execute the processes of some embodiments.

The bus 305 also connects to the input and output devices 330 and 335. The input devices enable the user to communicate information and select commands to the electronic system. The input devices 330 include alphanumeric keyboards and pointing devices (also called “cursor control devices”). The output devices 335 display images generated by the electronic system 300. The output devices 335 include printers and display devices, such as cathode ray tubes (CRT) or liquid crystal displays (LCD). Some embodiments include devices such as a touchscreen that functions as both input and output devices.

Finally, as shown in FIG. 3, bus 305 also couples electronic system 300 to a network 340 through a network adapter (not shown). In this manner, the computer can be a part of a network of computers (such as a local area network (“LAN”), a wide area network (“WAN”), or an Intranet), or a network of networks (such as the Internet). Any or all components of electronic system 300 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process is conceptually illustrated in FIG. 2. The specific operations of this process may not be performed in the exact order shown and described. Specific operations may not be performed in one continuous series of operations, and different specific operations may be performed in different embodiments. Furthermore, the process could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A home seller lead data procurement system that captures information from a potential home seller in an engaging and comprehensive manner, provides a property valuation to the potential home seller upon completion of a set of informational requests, and informs a real estate professional of the captured information from the potential home seller, said home seller lead data procurement system comprising:
a web server computing device that runs a property valuation service that is available on the Internet for computing devices of potential home sellers to access;
a website that is hosted on the web server computing device to run the property valuation service, said website comprising a plurality of web pages that the potential home seller accesses to complete a set of informational requests to receive a property valuation;
a property valuation engine that generates the property valuation based on informational responses to the informational requests received from a computing device of the potential home seller;
a database that stores the property valuation and informational responses for a real estate professional to access in connection with a request for a more accurate property valuation; and
a lead data procurement engine that informs the real estate professional about the potential home seller.

2. The home seller lead data procurement system of claim 1, wherein the plurality of web pages are displayed in sequence on the computing device of the potential home seller when the computing device of the potential home seller is accessing the website.

3. The home seller lead data procurement system of claim 1, wherein the set of informational responses comprises an address of a property.

4. The home seller lead data procurement system of claim 3, wherein the set of informational responses comprises a description of features of the property.

5. The home seller lead data procurement system of claim 3, wherein the set of informational responses comprises contact information of the potential home seller.

6. A non-transitory computer readable medium storing a home valuation information retrieval program which, when executed by at least one processing unit of a computing device, captures potential home seller information from a user seeking a valuation of a property, said home valuation information retrieval program comprising sets of instructions for:
displaying a first web page of a home seller lead data website, said first web page comprising a prompt for a user accessing the home seller data website to input an address of the property;
receiving a first set of input data comprising the address of the property;
identifying a location of the property based on the address of the property;
displaying a second web page of the home seller lead data website, said second web page comprising a map of the property and a prompt for the user to input additional property information;
receiving a second set of input data comprising details of the property and contact information of the user;
automatically generating the valuation of the property;
displaying a third web page of the home seller lead data website, said third web page comprising the automatically generated property valuation and a contact approval tool that allows the user to approve of further contact from a real estate professional; and
transmitting the address of the property, the details of the property, and the property valuation to the real estate professional.

7. The non-transitory computer readable medium of claim 6, wherein the valuation of the property is automatically generated based on the address of the property and the details of the property.

8. The non-transitory computer readable medium of claim 6, wherein the home valuation information retrieval program further comprises a set of instructions for saving the address of the property, the details of the property, and the property valuation in a database for future retrieval by the real estate professional.

9. The non-transitory computer readable medium of claim 6, wherein the home valuation information retrieval program further comprises a set of instructions for establishing the home seller lead data website, said home seller lead data website established by the real estate professional.

10. The non-transitory computer readable medium of claim 6, wherein the first set of data input and the second set of data input are received from a user computing device of the user, said user computing device accessing the home seller data website to transmit the first set of data input and the second set of data input.

11. The non-transitory computer readable medium of claim 6, wherein the program further comprises a set of instructions for receiving a selection of the contact approval tool from the user computing device.

12. The non-transitory computer readable medium of claim 11, wherein the program further comprises sets of instructions for:
alerting the real estate professional that the user has approved further contact from the real estate professional; and
transmitting the contact information of the user to the real estate professional.
